(19) United States
(12) Patent Application Publication
(10) Pub. No.: US 2023/0007040 A1
(43) Pub. Date: Jan. 5, 2023

(54) RECOMMENDATION OF GRANULAR TRAFFIC THRESHOLDS FROM MULTIPLE SENSOR APPLIANCES

(71) Applicant: Fortinet, Inc., Sunnyvale, CA (US)

(72) Inventor: Hemant Kumar Jain, Milpitas, CA (US)

(21) Appl. No.: 17/364,673

(22) Filed: Jun. 30, 2021

(51) Int. Cl. H04L 29/06

(52) U.S. Cl. CPC H04L 63/1458; H04L 63/1425; H04L 63/1416; H04L 63/20

(57) ABSTRACT

Recommendations are made for granular traffic thresholds for a plurality of DDoS attack mitigation appliances that act as a set appliances. The set of appliances can be those commonly found in highly available networks, active-active or active-passive appliances, disaster recovery data centers, backup appliances, etc.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright 2020, Fortinet, Inc.

### CROSS-REFERENCE TO RELATED PATENTS

This application may relate to the subject matter of U.S. Pat. No. 7,426,634 entitled, “Method and apparatus for rate based denial of service attack detection and prevention”, U.S. Pat. No. 7,602,731 entitled “System and method for integrated header, state, rate and content anomaly prevention with policy enforcement”, U.S. Pat. No. 7,626,940 entitled “System and method for integrated header, state, rate and content anomaly prevention for domain name service”, “System and Method for Integrated Header, State, Rate and Content Anomaly Prevention for Session Initiation Protocol”, U.S. Pat. No. 9,699,211 entitled “Scalable Inline Behavioral DDoS Attack Mitigation”, U.S. Pat. No. 9,729,584 entitled System and method for software defined behavioral DDoS attack mitigation” all of which are hereby incorporated by reference in their entirety for all purposes.

### FIELD

The invention relates generally to computer hardware and computer networks and, more specifically, to prevention of distributed denial of service (DDoS) attacks on networks exposed to the Internet.

### DESCRIPTION OF THE BACKGROUND ART

It is common knowledge that networks exposed to the Internet by enterprises or service providers are becoming complex. Many architectural schemes such as load balancing, high availability and disaster recovery are incorporated to make the networks more robust and not prone to failure.

A distributed denial of service (DDoS) attack mitigation equipment for Internet facing networks primarily work on behavioral anomalies on rates. For them to work, granular rate estimation on various traffic parameters is paramount as DDoS attacks appear primarily as change in the rate of traffic on one or more granular traffic parameters. The rates of traffic on granular parameters vary from network to network and therefore are relative statistics.

If there is only one appliance that's facing the network traffic, both inbound and outbound, the process is relatively simpler.

However, if there are multiple appliances that face the overall network traffic due to network architecture, a scheme is required to recommend the behavioral granular thresholds for correct identification of behavioral anomalies across the plurality of appliances.

### SUMMARY

The above-mentioned problem is addressed by a system consolidated automated recommendation of granular thresholds in a complex network of DDoS mitigation sensor appliances. In an exemplary active-active highly-available network setup traffic may distribute to two or more different mitigation appliances. And depending on network failures, traffic may distribute differently over time. In yet another exemplary highly available setup, traffic may switch to a secondary appliance when a primary appliance fails. In another exemplary situation, traffic may divert totally to a disaster recovery center appliance where earlier there was no traffic ever. A simple scheme of traffic behavior based on past traffic estimation does not work in these situations.

In an implementation, a distributed denial of service (DDoS) threshold recommendation engine within a network receives a plurality of traffic rate parameters from a plurality of DDoS attack mitigation appliances. The DDoS threshold recommendation engine determines a type of a set of appliances for the plurality of traffic rate parameters received. Rates of individual types of traffic parameters from the plurality of traffic rate parameters are combined, multiplying by a rate multiplier to avoid false positives and determining a maximum combined expected packet rate. The plurality of DDoS attack mitigation appliances are then fed back the traffic thresholds.

Other features of embodiments of the present disclosure will be apparent from accompanying drawings and from detailed description that follows.

### BRIEF DESCRIPTION OF THE DRAWINGS

FIG. 1 illustrates a single appliance facing the Internet and protecting a network for both the inbound and outbound traffic flows through the appliance, according to an embodiment.

FIG. 2 illustrates a few granular traffic parameters that would be used to recommend the thresholds, according to an embodiment.

FIG. 3 illustrates an exemplary technique for recommending thresholds based on granular traffic parameters in FIG. 2, according to an embodiment.

FIG. 4 illustrates deployment of a pair of DDoS Mitigation appliances in an exemplary active-active high availability mode, according to an embodiment.

FIG. 5 illustrates a few granular traffic parameters that would be used to recommend the combined thresholds on two appliances from FIG. 4, according to an embodiment.

FIG. 6 illustrates in accordance with an embodiment of the present invention a technique for recommending granular thresholds by combining data from two appliances in FIG. 4, according to an embodiment.

### DETAILED DESCRIPTION

A system and methods are described for recommending granular thresholds in complex network deployment of a plurality of DDoS attack mitigation appliances. According to one embodiment, in a load balanced network with active-active appliances, granular traffic rates of two appliances are combined to recommend the thresholds on two appliances. In yet another embodiment, the traffic of the two or more appliances may be such that one of the appliances has no traffic at all some time, as in case of disaster recovery center appliances and upon disaster suddenly gets all the traffic. In such a scenario, the recommended thresholds cannot use the behavior when traffic is zero—but must use the combined traffic of a plurality of non-disaster-recovery appliances facing the total traffic during normal times. One of ordinary skill in the art will recognize many different possibilities, within the spirit of the present disclosure.

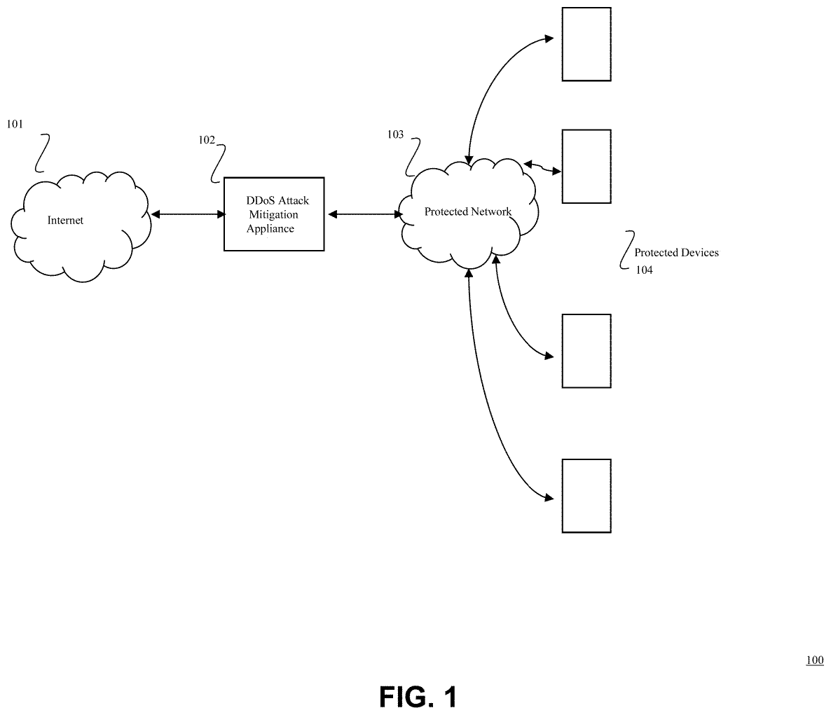

FIG. 1 illustrates a deployment 100 of a DDoS attack mitigation appliance 102 facing the Internet 101 and protecting a network 103 consisting of a plurality of devices 104. Both inbound and outbound traffic goes through the appliance 102. Therefore, the traffic behavior can be easily predicted and estimated for setting behavioral thresholds.

A method can implement the components of FIG. 1 according to the following steps: receiving, by a distributed denial of service (DDoS) threshold recommendation engine within a network, a plurality of traffic rate parameters from a plurality of DDoS attack mitigation appliances; determining, by the DDoS threshold recommendation engine, a type of a set of appliances for the plurality of traffic rate parameters received; combining rates of individual types of traffic parameters from the plurality of traffic rate parameters, multiplying by a rate multiplier to avoid false positives and determining a maximum combined expected packet rate; and feeding back to the plurality of DDoS attack mitigation appliances the traffic thresholds

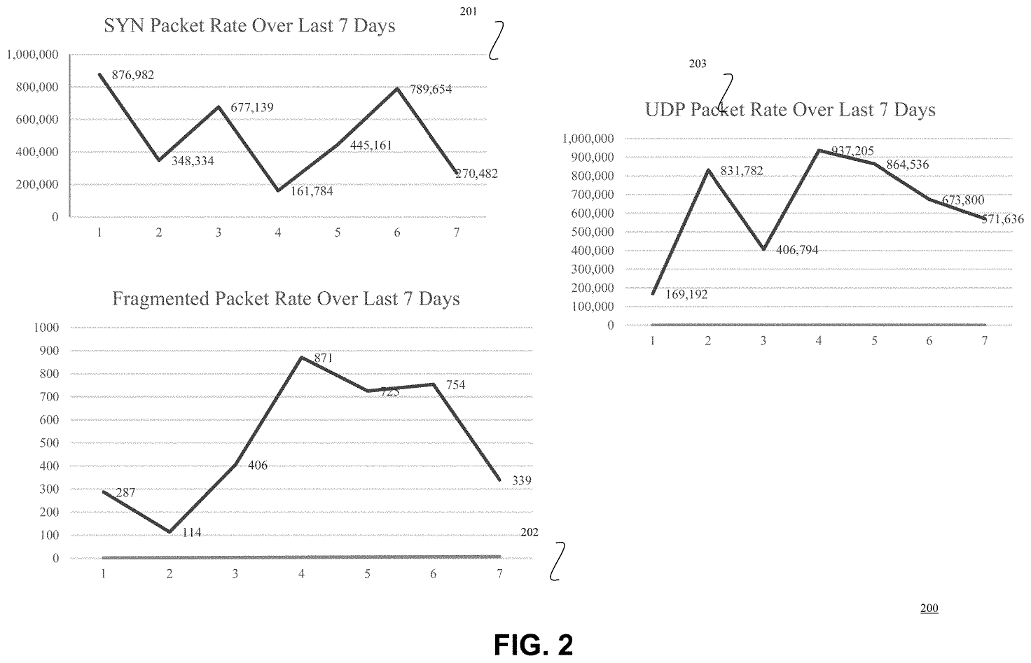

FIG. 2 illustrates a granular traffic behavior passing through the appliance in FIG. 1, 100. 3 graphs over last 7 days illustrate maximum traffic observed for 3 granular parameters, viz. SYN packets, fragmented packets, and UDP packets in inbound direction via the appliance 102. This traffic behavior can be used to estimate traffic thresholds for these granular parameters. These are exemplary parameters. One of ordinary skill in the art will appreciate a variety of other granular traffic behavior parameters such as HTTP Get Method rate, ICMP protocol rate, SIP Invite Rate, etc. exist in accordance with the aforementioned definition. These are maximum per second rates that can be observed via the mitigation appliance. In an exemplary situation, SYN packet rate over last 7 days, according to 201 never exceeded 876,982 packets per second any time. Similarly, Fragmented packets never arrived faster than 871 packets per second over the last 7 days. Similarly, UDP packet rate never exceeded 973,205 packets per second.

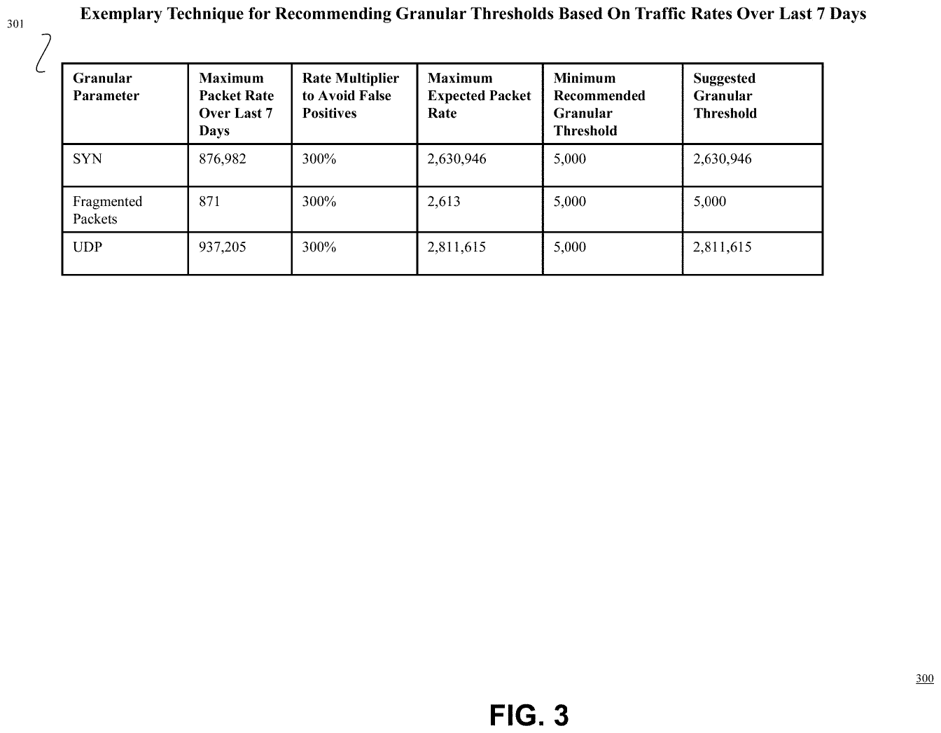

FIG. 3 illustrates an exemplary technique for recommending granular thresholds according to those skilled in the art. 301 shows a table. E.g. if maximum SYN rate observed is 876,982 packets per second (PPS), then from DDoS attack mitigation perspective, it would make sense to give some ‘cushion’ to avoid false positives. In an exemplary situation, this cushion could be 300% of the traffic observed. Thus, the threshold could be recommended at 2,630,946 which is 3× of the observed traffic rate for that parameter in the inbound direction. What this means is that until traffic exceeds 2,630,946 PPS for this granular traffic parameter, it is not considered an anomaly from DDoS perspective. Some traffic can have very low value during observation period but occasionally may reach reasonable value at another ‘normal’ time which are not DDoS attacks. Therefore, a concept of Minimum Recommended Granular Threshold can be used. In this case, say, 5,000 PPS. Since our 300% of observed rate for SYN is higher than this minimum, we can suggest a granular threshold to 2,630,946 PPS.

In case of Fragmented packets in the exemplary situation in table 301, the Maximum Expected Rate is still 2,613 which is below Minimum Recommended Granular Threshold of 5,000. Thus, a recommendation of 5,000 PPS is appropriate for these packets.

In a similar way, UDP packet threshold can be set to 2,811,615 according to this technique.

Those skilled in the art will appreciate that use of maximum here is only an exemplary technique. Other schemes such as 95th percentile to avoid sudden bursts can be used too. Similarly using last 7 days is an example, other periods such as last 1 month or last 1 year or last 24 hours can be used depending on what data is available and what is important to the system administrator.

An exemplary DDoS attack mitigation works on an integrated combination of a plurality of such traffic thresholds and violation of any one or more of such thresholds is considered an active traffic anomaly and is mitigated by limiting the rate of such anomalous packets selectively. Those skilled in the art are aware that the volume of traffic increase during an attack is manifold compared to baseline traffic. It is therefore not an issue of accuracy of these thresholds to exact per second value but about reasonable of these values. The attack rates are significantly higher compared to baseline rates. Those skilled in the art are aware that in an exemplary situation, the baseline traffic may be in 100 Mbps but the attack rates may be in 5 Gbps. In yet another deployment, the baseline may be around 5 Gbps and attack may be in 20 Gbps range.

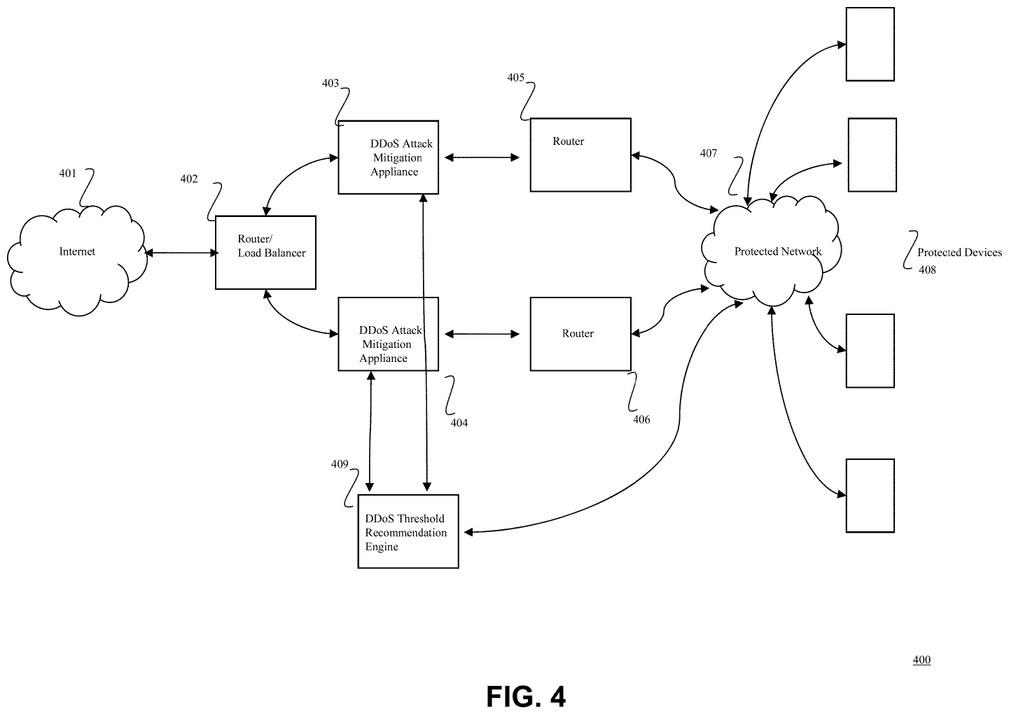

FIG. 4 illustrates a typical deployment 400 of DDoS attack mitigation appliances 403 and 404 facing the Internet 401 and protecting a network 407 consisting of a plurality of devices 408. In this exemplary active-active deployment, a router or a load balancer 402 at the ingress of this data center, sends traffic in a way to the two appliances 403 and 404 that not all traffic goes through one appliance. In a similar way, the outbound traffic from protected network 407 is via two routers 405 and 406. Thus, if one of the protected devices 408 has its default router pointing to 405, all its traffic outbound will be pass via 405 and thus via 403. In a similar way, if a one of the protected devices 408 has its default router pointing to 406, all its traffic outbound will pass via 406 and thus via 404. Therefore, the traffic passing via 403 and 404 will depend on network conditions and policies set by the administrator. These conditions and policies may vary over time. Thus, balance of traffic over period of time may vary substantially while keeping the total traffic via the system around the same predicable baseline.

A DDoS threshold recommendation engine 105 can provide network support to each of the DDoS attack mitigation appliances. In one implementation, residence on the protected network provides direct communication with network devices. In another implementation on the Internet, cloud-based support gathers experience from across many different protected networks. Rates are sent from 402,404 and thresholds are returned to 402,404.

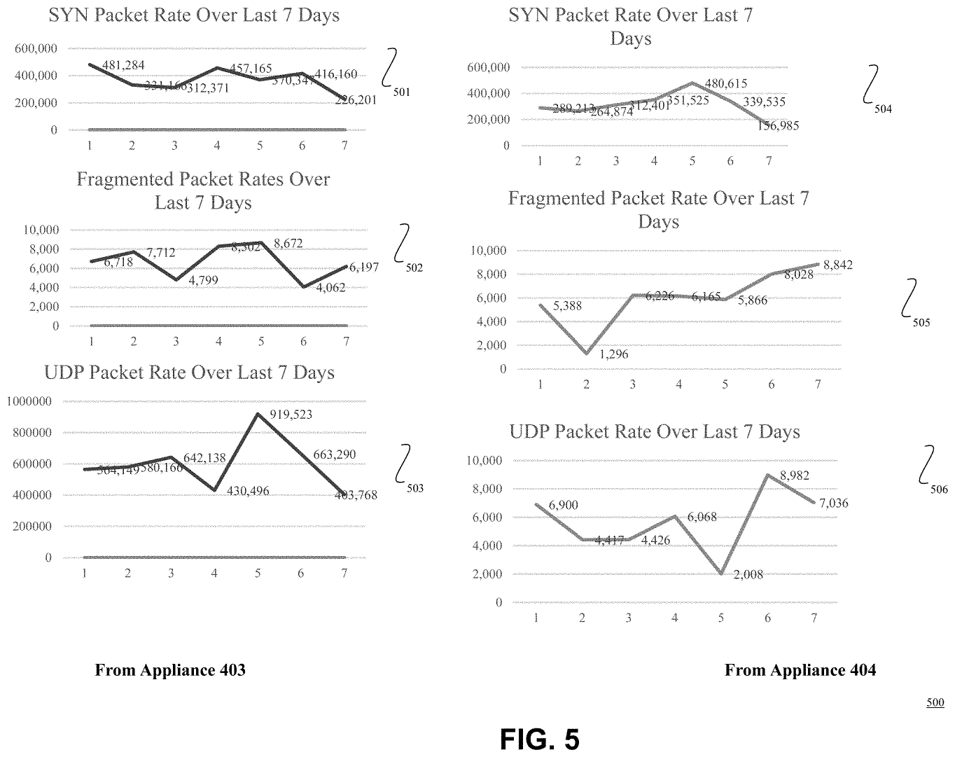

FIG. 5 illustrates a typical granular traffic behavior passing through the appliances 403 and 404 in FIG. 4, 400. 3 graphs 501, 502 and 503 illustrate maximum traffic observed for 3 granular parameters, viz. SYN packets, fragmented packets, and UDP packets in inbound direction via the appliance 403.

The other 3 graphs 504, 505 and 506 illustrate maximum traffic observed for 3 granular parameters, viz. SYN packets, fragmented packets, and UDP packets in inbound direction via the appliance 404.

In this exemplary situation, SYN packet rate over last 7 days, according to 501 never exceeded 481,284 PPS any time. Similarly, Fragmented packets never arrived faster than 8,672 PPS over the last 7 days. Similarly, UDP packet rate never exceeded 919,523 PPS on appliance 403.

In this exemplary situation, SYN packet rate over last 7 days, according to 504 never exceeded 480,615 PPS any time. Similarly, Fragmented packets never arrived faster than 8,842 PPS over the last 7 days. Similarly, UDP packet rate never exceeded 8,982 PPS on appliance 404.

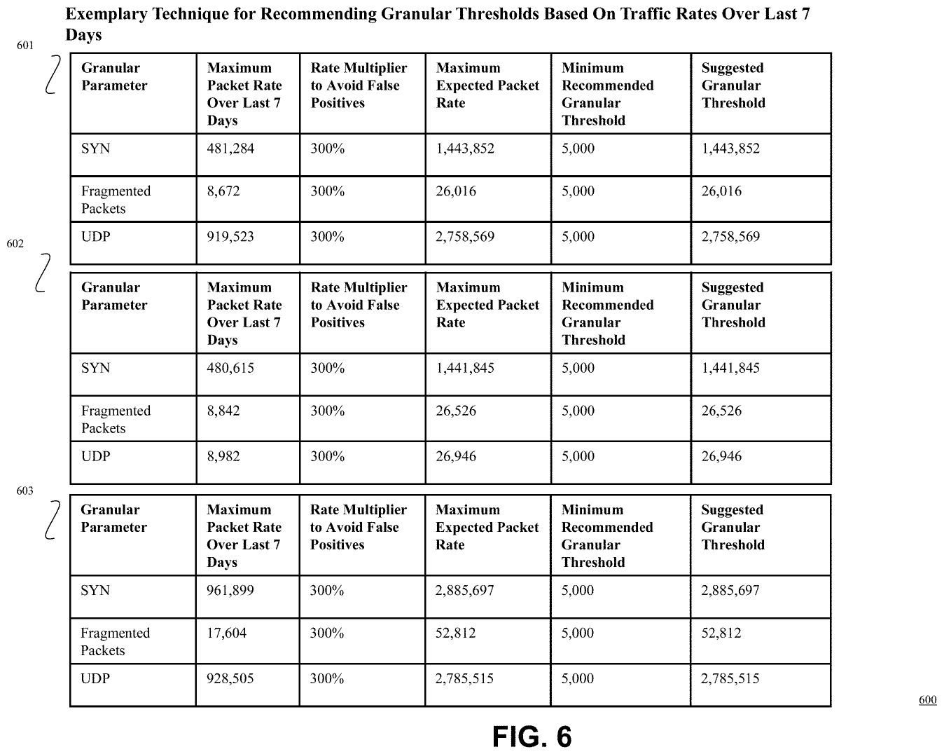

FIG. 6 illustrates an exemplary technique for recommending granular thresholds according to an embodiment of this invention. 601 shows a table corresponding to graphs 501, 502, and 503. 602 shows a table corresponding to graphs 504, 505, and 506. And, 603 shows a table according to an embodiment of this invention, a technique to arrive at common threshold for plurality of the appliances based on table 601 and 602.

As explained in earlier section, we can derive the suggested Granular Threshold for appliance 403 as 1,443,852 for SYN Packets, 26,016 for fragmented packets, and 2,758,569 as depicted in Table 601.

In a similar way, as explained in earlier section, we can derive the suggested Granular Threshold for appliance 404 as 1,441,845 for SYN Packets, 26,526 for fragmented packets, and 26,946 as depicted in Table 602.

According to an embodiment of this invention, since the two appliances 403 and 404 share the total traffic under various scenarios such as load balancing, routing changes, disaster recovery, high availability, keeping their thresholds based on just their traffic behavior is not the most appropriate technique. According to an embodiment of this invention, the appliances will not exceed the cumulative traffic at any given moment under the above scenarios. Thus, if the traffic of two appliances with due cushion is summed up, the thresholds can be predicted based on that new value. Table 603 shows such a scheme according to an embodiment of this invention. In the exemplary situation, rates of SYN, fragmented packets, and UPD packets from 601 and 602 and the cumulative values are used as a baseline. The resultant thresholds are deployed on both the appliances. These new thresholds ensure that whether traffic moves from one to the other fully or partially or in a random way, both the appliances are generally ready to mitigate the rate anomalies based on the new thresholds.

In yet another embodiment of the invention, the plurality of the appliances is not limited to two appliances but could be higher.

In yet another embodiment of the invention, the thresholds are not limited to those mentioned above but could be those parameters that could be obtained from packets and sessions of the packets through packet classification and other techniques known to those in the art.

In another embodiment of the invention, the direction of the anomalies is not limited to inbound packets, but could be outbound as well—as those who are skilled in the art are aware that there are outbound attacks as well.

Components described above are meant only to exemplify various possibilities. In no way should the aforementioned exemplary computer system limit the scope of the present disclosure.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

Although embodiments of the present invention and their various advantages have been described in detail, it should be understood that the present invention is not limited to or defined by what is shown or discussed herein.

Moreover, as one skilled in the art will appreciate, any digital computer systems can be configured or otherwise programmed to implement the methods and apparatuses disclosed herein, and to the extent that a particular digital computer system is configured to implement the methods and apparatuses of this invention, it is within the scope and spirit of the present invention. Once a digital computer system is programmed to perform particular functions pursuant to computer-executable instructions from program software that implements the present invention, it in effect becomes a special purpose computer particular to the present invention. The techniques necessary to achieve this are well known to those skilled in the art and thus are not further described herein.

Computer executable instructions implementing the methods and techniques of the present invention can be distributed to users on a computer-readable medium and are often copied onto a hard disk or other storage medium. When such a program of instructions is to be executed, it is usually loaded into the random-access memory of the computer, thereby configuring the computer to act in accordance with the techniques disclosed herein. All these operations are well known to those skilled in the art and thus are not further described herein. The term “computer-readable medium” encompasses distribution media, intermediate storage media, execution memory of a computer, and any other medium or device capable of storing for later reading by a computer a computer program implementing the present invention.

Accordingly, drawings, tables, and description disclosed herein illustrate technologies related to the invention, show examples of the invention, and provide examples of using the invention and are not to be construed as limiting the present invention. Known methods, techniques, or systems may be discussed without giving details, so to avoid obscuring the principles of the invention. As it will be appreciated by one of ordinary skill in the art, the present invention can be implemented, modified, or otherwise altered without departing from the principles and spirit of the present invention. Therefore, the scope of the present invention should be determined by the following claims and their legal equivalents.

What is claimed is:

1. A computer-implemented method in a distributed denial of service (DDoS) attack mitigation server, the method comprising:
receiving, by a DDoS threshold recommendation engine within a network, a plurality of traffic rate parameters from a plurality of DDoS attack mitigation appliances;
determining, by the DDoS threshold recommendation engine, a type of a set of appliances for the plurality of traffic rate parameters received;
combining rates of individual types of traffic parameters from the plurality of traffic rate parameters, multiplying by a rate multiplier to avoid false positives and determining a maximum combined expected packet rate; and
feeding back to the plurality of DDoS attack mitigation appliances the traffic thresholds.

2. The method of claim 1, further comprising:
determining if the set of appliances consists of a plurality of active-active appliances.

3. The method of claim 1, further comprising:
determining if the set of appliances consists of a plurality of active-passive appliances.

4. The method of claim 1, further comprising:
determining if the set of appliances consists of a plurality of appliances that are part of load balanced appliances facing the same network.

5. The method of claim 1, further comprising:
determining if the set of appliances consists of a plurality of appliances that are part of the same highly available network facing the same cumulative traffic.

6. The method of claim 1, further comprising:
determining if the set of appliances consists of a plurality of appliances that are part of a set, some of which may be used under disaster recovery and some that face the network traffic under normal circumstances.

7. The method of claim 1, further comprising:
determining if the set of appliances consists of a plurality of appliances that are part of a set, some of which may be used as a backup if the primary appliances fail.

8. The method of claim 1, further comprising:
combining the rates of individual granular traffic parameters from the whole set, multiplying by a rate multiplier to avoid false positives and determining a maximum combined expected packet rate.

9. The method of claim 1, further comprising:
determining a final set of granular thresholds.

10. The method of claim 9, further comprising:
deploying this set of thresholds on all the appliances that belong to the set of mitigation appliances.

11. A non-transitory computer-readable medium storing sourced code that, when executed by a processor, performs a method in a distributed denial of service (DDoS) attack mitigation server, the method comprising:
receiving, by a DDoS threshold recommendation engine within a network, a plurality of traffic rate parameters from a plurality of DDoS attack mitigation appliances;
determining, by the DDoS threshold recommendation engine, a type of a set of appliances for the plurality of traffic rate parameters received;
combining rates of individual types of traffic parameters from the plurality of traffic rate parameters, multiplying by a rate multiplier to avoid false positives and determining a maximum combined expected packet rate; and
feeding back to the plurality of DDoS attack mitigation appliances the traffic thresholds.

12. A distributed denial of service (DDoS) attack mitigation server, comprising:
receiving, by a DDoS threshold recommendation engine within a network, a plurality of traffic rate parameters from a plurality of DDoS attack mitigation appliances;
determining, by the DDoS threshold recommendation engine, a type of a set of appliances for the plurality of traffic rate parameters received;
combining rates of individual types of traffic parameters from the plurality of traffic rate parameters, multiplying by a rate multiplier to avoid false positives and determining a maximum combined expected packet rate; and
feeding back to the plurality of DDoS attack mitigation appliances the traffic thresholds.
